(19) United States
(12) Patent Application Publication
(10) Pub. No.: US 2026/0065564 A1
(43) Pub. Date: Mar. 5, 2026

(54) MAPPING ANIMATION DATA TO AN AVATAR FORMAT FOR EXTENDED REALITY (XR) MEDIA COMMUNICATION SESSIONS

(71) Applicant: QUALCOMM Incorporated, San Diego, CA (US)

(72) Inventors: Imed Bouazizi, Celina, TX (US); Michel Adib Sarkis, San Diego, CA (US); Thomas Stockhammer, Bergen (DE); Nikolai Konrad Leung, San Francisco, CA (US)

(21) Appl. No.: 19/311,506

(22) Filed: Aug. 27, 2025

Related U.S. Application Data
(60) Provisional application No. 63/689,398, filed on Aug. 30, 2024.

(51) Int. Cl. G06T 13/40; G06V 20/20; G06V 40/16; H04L 65/1089

(52) U.S. Cl. CPC G06T 13/40; G06V 20/20; G06V 40/171; G06V 40/174; H04L 65/1089

(57) ABSTRACT

An example device for communicating augmented reality (AR) media data includes: a memory configured to store AR media data; and a processing system implemented in circuitry and configured to: receive mapping information including data defining mappings between a first framework defining input animations of an AR media communication session and corresponding output animations of a second framework to be used to animate a base avatar model of a user participating in the AR media communication session; receive an animation stream for the user, the animation stream including data for one or more of the input animations; determine a subset of the output animations to be used to animate the base avatar model of the user using the mapping information and the one or more of the input animations from the animation stream; and animate the base avatar model using the subset of the output animations.

This application claims the benefit of U.S. Provisional Application No. 63/689,398, filed Aug. 30, 2024, the entire contents of which are hereby incorporated by reference.

### TECHNICAL FIELD

This disclosure relates to transport of media data, in particular, extended reality media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The video data may be assembled into a media file conforming to any of a variety of standards, such as the International Organization for Standardization (ISO) base media file format and extensions thereof.

### SUMMARY

In general, this disclosure describes techniques for processing extended reality (XR) media data. XR media data may include any or all of augmented reality (AR) data, mixed reality (MR) data, or virtual reality (VR) data. This disclosure generally refers to “AR,” but such references may also be understood to include XR, MR, and VR. During an AR communication session, a user may be represented by an avatar. The avatar may correspond to a base model. Throughout the AR communication session, the user may move their body, face, hands, or the like. These movements may be tracked by various devices, and this tracked data may be used to animate the base model of the avatar. For example, the avatar may be animated to match movements of the user, facial expressions of the user, poses of the user, or the like. The base model and tracked movement data may be tracked in different frameworks, which may have different representations and capacities for expressing movements, such as different facial expressions, different rigging skeletons (sets of bones and joints) for the base model, or the like. This disclosure describes techniques that may be used to convert from a tracking framework to a framework for the base model to ensure that the base model can be properly animated.

In one example, a method of communicating augmented reality (AR) media data includes: receiving mapping information including data defining mappings between a first framework defining input animations of an AR media communication session and corresponding output animations of a second framework to be used to animate a base avatar model of a user participating in the AR media communication session; receiving an animation stream for the user, the animation stream including data for one or more of the input animations; determining a subset of the output animations to be used to animate the base avatar model of the user using the mapping information and the one or more of the input animations from the animation stream; and animating the base avatar model using the subset of the output animations.

In another example, an device for communicating augmented reality (AR) media data includes: a memory configured to store AR media data; and a processing system implemented in circuitry and configured to: receive mapping information including data defining mappings between a first framework defining input animations of an AR media communication session and corresponding output animations of a second framework to be used to animate a base avatar model of a user participating in the AR media communication session; receive an animation stream for the user, the animation stream including data for one or more of the input animations; determine a subset of the output animations to be used to animate the base avatar model of the user using the mapping information and the one or more of the input animations from the animation stream; and animate the base avatar model using the subset of the output animations.

In another example, a device for communicating augmented reality (AR) media data includes: means for receiving mapping information including data defining Qualcomm Ref. No. 2406960 mappings between a first framework defining input animations of an AR media communication session and corresponding output animations of a second framework to be used to animate a base avatar model of a user participating in the AR media communication session; means for receiving an animation stream for the user, the animation stream including data for one or more of the input animations; means for determining a subset of the output animations to be used to animate the base avatar model of the user using the mapping information and the one or more of the input animations from the animation stream; and means for animating the base avatar model using the subset of the output animations.

In another example, a computer-readable storage medium has stored thereon instructions that, when executed, cause a processor to: receive mapping information including data defining mappings between a first framework defining input animations of an AR media communication session and corresponding output animations of a second framework to be used to animate a base avatar model of a user participating in the AR media communication session; receive an animation stream for the user, the animation stream including data for one or more of the input animations; determine a subset of the output animations to be used to animate the base avatar model of the user using the mapping information and the one or more of the input animations from the animation stream; and animate the base avatar model using the subset of the output animations.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example network including various devices for performing the techniques of this disclosure.

FIG. 2 is a block diagram illustrating an example computing system that may perform split rendering techniques.

FIG. 3 is a flowchart illustrating an example method of performing split rendering.

FIG. 4 is a block diagram illustrating an example set of devices that may perform various aspects of the techniques of this disclosure.

FIG. 5 is a conceptual diagram illustrating an example set of data that may be used in an extended reality (XR) session per techniques of this disclosure.

FIG. 6 is a flowchart illustrating a method of animating a base avatar according to a framework for the base avatar and a tracking framework per the techniques of this disclosure.

FIG. 7 is a flow diagram illustrating an example method for exchanging avatar data for a communications session.

FIG. 8 is a block diagram illustrating an example animation system for 3D models.

FIG. 9 is a graph representing an example set of components of a base avatar description, also referred to as an MPEG Avatar Representation Format (MARF) document.

FIG. 10 is a block diagram illustrating an example system for ensuring that a base avatar model is used by a corresponding user who owns the base avatar model.

FIG. 11 is a flowchart illustrating an example method of using mapping data to determine animations to be used to animate a base avatar model in a supported framework when an animation stream includes animations expressed an unsupported framework, per techniques of this disclosure.

### DETAILED DESCRIPTION

In general, this disclosure describes techniques for transporting and processing extended reality (XR) media data, such as augmented reality (AR) media data, mixed reality (MR) media data, or virtual reality (VR) media data. Immersive AR experiences are based on shared virtual spaces, where people (represented by avatars) join and interact with each other and the environment. Avatars may be realistic representations of the user or may be a “cartoonish” representation. Avatars may be animated to mimic the user's body pose and facial expressions.

A display device (or another device) may capture facial movements of the user. For example, the display device may include one or more cameras or other sensors for detecting facial expressions and/or movements of the user, e.g., smiling, neutral, frowning, or mouth and jaw movements that occur when the user speaks. The display device may encode data representative of such facial movements and send the encoded data to a receiving device, such that the receiving device can animate the user's avatar consistent with the user's facial movements.

A receiving device may render received AR media data. Such rendering may be performed on a single device or using split rendering. A split rendering server may perform at least part of a rendering process to form rendered images, then stream the rendered images to a display device, such as AR glasses or a head mounted display (HMID). In general, a user may wear the display device, and the display device may capture pose information, such as a user position and orientation/rotation in real world space, which may be translated to render images for a viewport in a virtual world space.

Split rendering may enhance a user experience through providing access to advanced and sophisticated rendering that otherwise may not be possible or may place excess power and/or processing demands on AR glasses or a user equipment (UE) device. In split rendering all or parts of the 3D scene are rendered remotely on an edge application server, also referred to as a “split rendering server” in this disclosure. The results of the split rendering process are streamed down to the UE or AR glasses for display. The spectrum of split rendering operations may be wide, ranging from full pre-rendering on the edge to offloading partial, processing-extensive rendering operations to the edge.

The display device (e.g., UE/AR glasses) may stream pose predictions to the split rendering server at the edge. That is, the split rendering server may be an edge application server (EAS) device, at an edge of a core network associated with a radio access network (RAN), where the UE may be communicatively coupled to a base station (such as a gNode B) of the RAN. The display device may then receive rendered media for display from the split rendering server. The XR runtime may be configured to receive rendered data together with associated pose information (e.g., information indicating the predicted pose for which the rendered data was rendered) for proper composition and display. For instance, the XR runtime may need to perform pose correction to modify the rendered data according to an actual pose of the user at the display time.

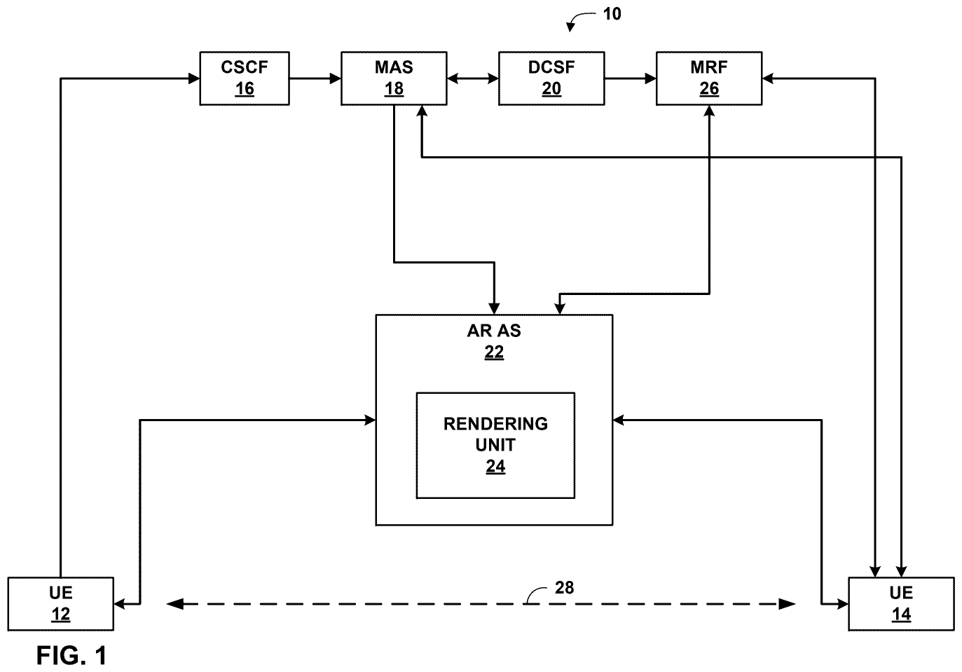

FIG. 1 is a block diagram illustrating an example network 10 including various devices for performing the techniques of this disclosure. In this example, network 10 includes user equipment (UE) devices 12, 14, call session control function (CSCF) 16, multimedia application server (MAS) 18, data channel signaling function (DCSF) 20, multimedia resource function (RF) 26, and augmented reality application server (AR AS) 22. MAS 18 may correspond to a multimedia telephony application server, an IP Multimedia Subsystem (IMS) application server, or the like.

UEs 12, 14 represent examples of UEs that may participate in an AR communication session 28. AR communication session 28 may generally represent a communication session during which users of UEs 12, 14 exchange voice, video, and/or AR data (and/or other XR data). For example, AR communication session 28 may represent a conference call during which the users of UEs 12, 14 may be virtually present in a virtual conference room, which may include a virtual table, virtual chairs, a virtual screen or white board, or other such virtual objects. The users may be represented by avatars, which may be realistic or cartoonish depictions of the users in the virtual AR scene. The users may interact with virtual objects, which may cause the virtual objects to move or trigger other behaviors in the virtual scene. Furthermore, the users may navigate through the virtual scene, and a user's corresponding avatar may move according to the user's movements or movement inputs. In some examples, the users' avatars may include faces that are animated according to the facial movements of the users (e.g., to represent speech or emotions, e.g., smiling, thinking, frowning, or the like).

UEs 12, 14 may exchange AR media data related to a virtual scene, represented by a scene description. Users of UEs 12, 14 may view the virtual scene including virtual objects, as well as user AR data, such as avatars, shadows cast by the avatars, user virtual objects, user provided documents such as slides, images, videos, or the like, or other such data. Ultimately, users of UEs 12, 14 may experience an AR call from the perspective of their corresponding avatars (in first or third person) of virtual objects and avatars in the scene.

UEs 12, 14 may collect pose data for users of UEs 12, 14, respectively. For example, UEs 12, 14 may collect pose data including a position of the users, corresponding to positions within the virtual scene, as well as an orientation of a viewport, such as a direction in which the users are looking (i.e., an orientation of UEs 12, 14 in the real world, corresponding to virtual camera orientations). UEs 12, 14 may provide this pose data to AR AS 22 and/or to each other.

CSCF 16 may be a proxy CSCF (P-CSCF), an interrogating CSCF (I-CSCF), or serving CSCF (S-CSCF). CSCF 16 may generally authenticate users of UEs 12 and/or 14, inspect signaling for proper use, provide quality of service (QoS), provide policy enforcement, participate in session initiation protocol (SIP) communications, provide session control, direct messages to appropriate application server(s), provide routing services, or the like. CSCF 16 may represent one or more I/S/P CSCFs.

MAS 18 represents an application server for providing voice, video, and other telephony services over a network, such as a 5G network. MAS 18 may provide telephony applications and multimedia functions to UEs 12, 14.

DCSF 20 may act as an interface between MAS 18 and MRF 26, to request data channel resources from MRF 26 and to confirm that data channel resources have been allocated. DCSF 20 may receive event reports from MAS 18 and determine whether an AR communication service is permitted to be present during a communication session (e.g., an IMS communication session).

MRF 26 may be an enhanced MRF (eMRF) in some examples. In general, MRF 26 generates scene descriptions for each participant in an AR communication session.

MRF 26 may support an AR conversational service, e.g., including providing transcoding for terminals with limited capabilities. MRF 26 may collect spatial and media descriptions from UEs 12, 14 and create scene descriptions for symmetrical AR call experiences. In some examples, rendering unit 24 may be included in MRF 26 instead of AR AS 22, such that MRF 26 may provide remote AR rendering services, as discussed in greater detail below.

MRF 26 may request data from UEs 12, 14 to create a symmetric experience for users of UEs 12, 14. The requested data may include, for example, a spatial description of a space around UEs 12, 14; media properties representing AR media that each of UEs 12, 14 will be sending to be incorporated into the scene; receiving media capabilities of UEs 12, 14 (e.g., decoding and rendering/hardware capabilities, such as a display resolution); and information based on detecting location, orientation, and capabilities of physical world devices that may be used in an audio-visual communication sessions. Based on this data, MRF 26 may create a scene that defines placement of each user and AR media in the scene (e.g., position, size, depth from the user, anchor type, and recommended resolution/quality); and specific rendering properties for AR media data (e.g., if 2D media should be rendered with a “billboarding” effect such that the 2D media is always facing the user). MRF 26 may send the scene data to each of UEs 12, 14 using a supported scene description format.

AR AS 22 may participate in AR communication session 28. For example, AR AS 22 may provide AR service control related to AR communication session 28. AR service control may include AR session media control and AR media capability negotiation between UEs 12, 14 and rendering unit 24.

AR AS 22 also includes rendering unit 24, in this example. Rendering unit 24 may perform split rendering on behalf of at least one of UEs 12, 14. In some examples, two different rendering units may be provided. In general, rendering unit 24 may perform a first set of rendering tasks for, e.g., UE 14, and UE 14 may complete the rendering process, which may include warping rendered viewport data to correspond to a current view of a user of UE 14. For example, UE 14 may send a predicted pose (position and orientation) of the user to rendering unit 24, and rendering unit 24 may render a viewport according to the predicted pose. However, if the actual pose is different than the predicted pose at the time video data is to be presented to a user of UE 14, UE 14 may warp the rendered data to represent the actual pose (e.g., if the user has suddenly changed movement direction or turned their head).

While only a single rendering unit is shown in the example of FIG. 1, in other examples, each of UEs 12, 14 may be associated with a corresponding rendering unit. Rendering unit 24 as shown in the example of FIG. 1 is included in AR AS 22, which may be an edge server at an edge of a communication network. However, in other examples, rendering unit 24 may be included in a local network of, e.g., UE 12 or UE 14. For example, rendering unit 24 may be included in a PC, laptop, tablet, or cellular phone of a user, and UE 14 may correspond to a wireless display device, e.g., AR/VR/MHR/XR glasses or head mounted display (HMD). Although two UEs are shown in the example of FIG. 1, in general, multi-participant AR calls are also possible.

UEs 12, 14, and AR AS 22 may communicate AR data using a network communication protocol, such as Real-time Transport Protocol (RTP), which is standardized in Request for Comment (RFC) 3550 by the Internet Engineering Task Force (IETF). These and other devices involved in RTP communications may also implement protocols related to RTP, such as RTP Control Protocol (RTCP), Real-time Streaming Protocol (RTSP), Session Initiation Protocol (SIP), and/or Session Description Protocol (SDP).

In general, an RTP session may be established as follows. UE 12, for example, may receive an RTSP describe request from, e.g., UE 14. The RTSP describe request may include data indicating what types of data are supported by UE 14. UE 12 may respond to UE 14 with data indicating media streams that can be sent to UE 14, along with a corresponding network location identifier, such as a uniform resource locator (URL) or uniform resource name (URN).

UE 12 may then receive an RTSP setup request from UE 14. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on UE 14. UE 12 may reply to the RTSP setup request with a confirmation and data representing ports of UE 12 by which the RTP data and control data will be sent. UE 12 may then receive an RTSP play request, to cause the media stream to be “played,” i.e., sent to UE 14. UE 12 may also receive an RTSP teardown request to end the streaming session, in response to which, UE 12 may stop sending media data to UE 14 for the corresponding session.

UE 14, likewise, may initiate a media stream by initially sending an RTSP describe request to UE 12. The RTSP describe request may indicate types of data supported by UE 14. UE 14 may then receive a reply from UE 12 specifying available media streams, such as media content 64, that can be sent to UE 14, along with a corresponding network location identifier, such as a uniform resource locator (URL) or uniform resource name (URN).

UE 14 may then generate an RTSP setup request and send the RTSP setup request to UE 12. As noted above, the RTSP setup request may contain the network location identifier for the requested media data (e.g., media content 64) and a transport specifier, such as local ports for receiving RTP data and control data (e.g., RTCP data) on UE 14. In response, UE 14 may receive a confirmation from UE 12, including ports of UE 12 that UE 12 will use to send media data and control data.

After establishing a media streaming session (e.g., AR communication session 28) between UE 12 and UE 14, UE 12 exchange media data (e.g., packets of media data) with UE 14 according to the media streaming session. UE 12 and UE 14 may exchange control data (e.g., RTCP data) indicating, for example, reception statistics by UE 14, such that UEs 12, 14 can perform congestion control or otherwise diagnose and address transmission faults.

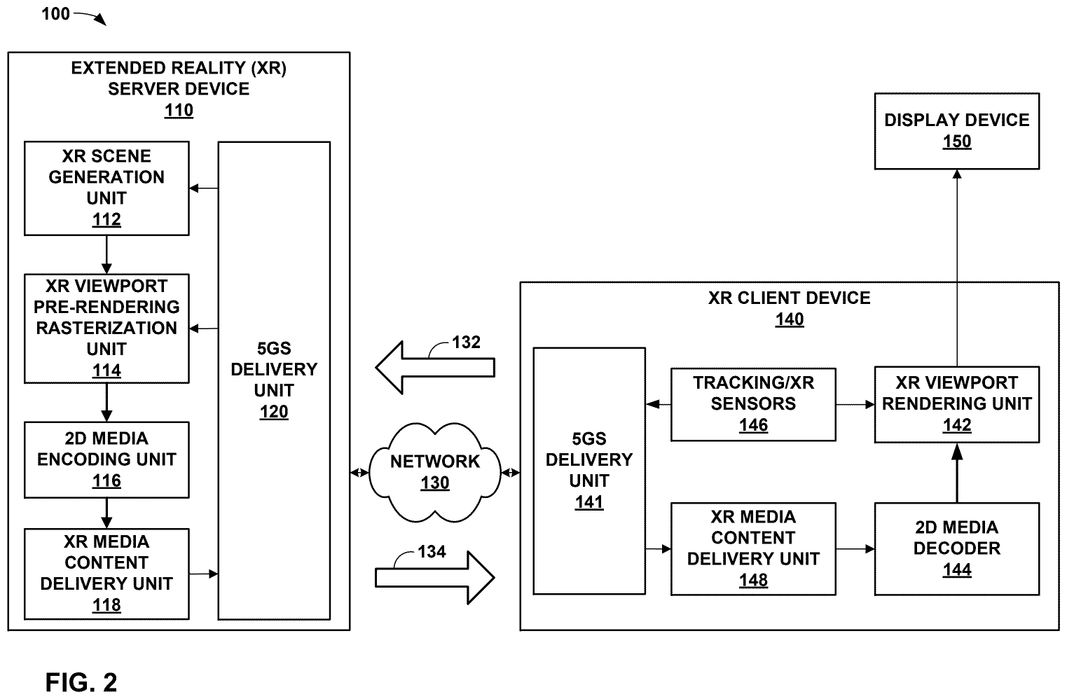

FIG. 2 is a block diagram illustrating an example computing system 100 that may perform split rendering techniques. In this example, computing system 100 includes extended reality (XR) server device 110, network 130, XR client device 140, and display device 150. XR server device 110 includes XR scene generation unit 112, XR viewport pre-rendering rasterization unit 114, 2D media encoding unit 116, XR media content delivery unit 118, and 5G System (5GS) delivery unit 120.

Network 130 may correspond to any network of computing devices that communicate according to one or more network protocols, such as the Internet. In particular, network 130 may include a 5G radio access network (RAN) including an access device to which XR client device 140 connects to access network 130 and XR server device 110. In other examples, other types of networks, such as other types of RANs, may be used. For example, network 130 may represent a wireless or wired local network. In other examples, XR client device 140 and XR server device 110 may communicate via other mechanisms, such as Bluetooth, a wired universal serial bus (USB) connection, or the like. XR client device 140 includes 5GS delivery unit 141, tracking/XR sensors 146, XR viewport rendering unit 142, 2D media decoder 144, and XR media content delivery unit 148. XR client device 140 also interfaces with display device 150 to present XR media data to a user (not shown).

In some examples, XR scene generation unit 112 may correspond to an interactive media entertainment application, such as a video game, which may be executed by one or more processors implemented in circuitry of XR server device 110. XR viewport pre-rendering rasterization unit 114 may format scene data generated by XR scene generation unit 112 as pre-rendered two-dimensional (2D) media data (e.g., video data) for a viewport of a user of XR client device 140. 2D media encoding unit 116 may encode formatted scene data from XR viewport pre-rendering rasterization unit 114, e.g., using a video encoding standard, such as ITU-T H.264/Advanced Video Coding (AVC), ITU-T H.265/High Efficiency Video Coding (HEVC), ITU-T H.266 Versatile Video Coding (VVC), or the like. XR media content delivery unit 118 represents a content delivery sender, in this example. In this example, XR media content delivery unit 148 represents a content delivery receiver, and 2D media decoder 144 may perform error handling.

In general, XR client device 140 may determine a user's viewport, e.g., a direction in which a user is looking and a physical location of the user, which may correspond to an orientation of XR client device 140 and a geographic position of XR client device 140. Tracking/XR sensors 146 may determine such location and orientation data, e.g., using cameras, accelerometers, magnetometers, gyroscopes, or the like. Tracking/XR sensors 146 provide location and orientation data to XR viewport rendering unit 142 and 5GS delivery unit 141. XR client device 140 provides tracking and sensor information 132 to XR server device 110 via network 130. XR server device 110, in turn, receives tracking and sensor information 132 and provides this information to XR scene generation unit 112 and XR viewport pre-rendering rasterization unit 114. In this manner, XR scene generation unit 112 can generate scene data for the user's viewport and location, and then pre-render 2D media data for the user's viewport using XR viewport pre-rendering rasterization unit 114. XR server device 110 may therefore deliver encoded, pre-rendered 2D media data 134 to XR client device 140 via network 130, e.g., using a 5G radio configuration.

XR scene generation unit 112 may receive data representing a type of multimedia application (e.g., a type of video game), a state of the application, multiple user actions, or the like. XR viewport pre-rendering rasterization unit 114 may format a rasterized video signal. 2D media encoding unit 116 may be configured with a particular 'er/decoder (codec), bitrate for media encoding, a rate control algorithm and corresponding parameters, data for forming slices of pictures of the video data, low latency encoding parameters, error resilience parameters, intra-prediction parameters, or the like. XR media content delivery unit 118 may be configured with real-time transport protocol (RTP) parameters, rate control parameters, error resilience information, and the like. XR media content delivery unit 148 may be configured with feedback parameters, error concealment algorithms and parameters, post correction algorithms and parameters, and the like.

Raster-based split rendering refers to the case where XR server device 110 runs an XR engine (e.g., XR scene generation unit 112) to generate an XR scene based on information coming from an XR device, e.g., XR client device 140 and tracking and sensor information 132. XR server device 110 may rasterize an XR viewport and perform XR pre-rendering using XR viewport pre-rendering rasterization unit 114.

In the example of FIG. 2, the viewport is predominantly rendered in XR server device 110, but XR client device 140 is able to do latest pose correction, for example, using asynchronous time-warping or other XR pose correction to address changes in the pose. XR graphics workload may be split into rendering workload on a powerful XR server device 110 (in the cloud or the edge) and pose correction (such as asynchronous timewarp (ATW)) on XR client device 140. Low motion-to-photon latency is preserved via on-device Asynchronous Time Warping (ATW) or other pose correction methods performed by XR client device 140.

The various components of XR server device 110, XR client device 140, and display device 150 may be implemented using one or more processors implemented in circuitry, such as one or more digital signal processors (DSPs), general purpose microprocessors, application specific integrated circuits (ASICs), field programmable logic arrays (FPGAs), or other equivalent integrated or discrete logic circuitry. The functions attributed to these various components may be implemented in hardware, software, or firmware. When implemented in software or firmware, it should be understood that instructions for the software or firmware may be stored on a computer-readable medium and executed by requisite hardware.

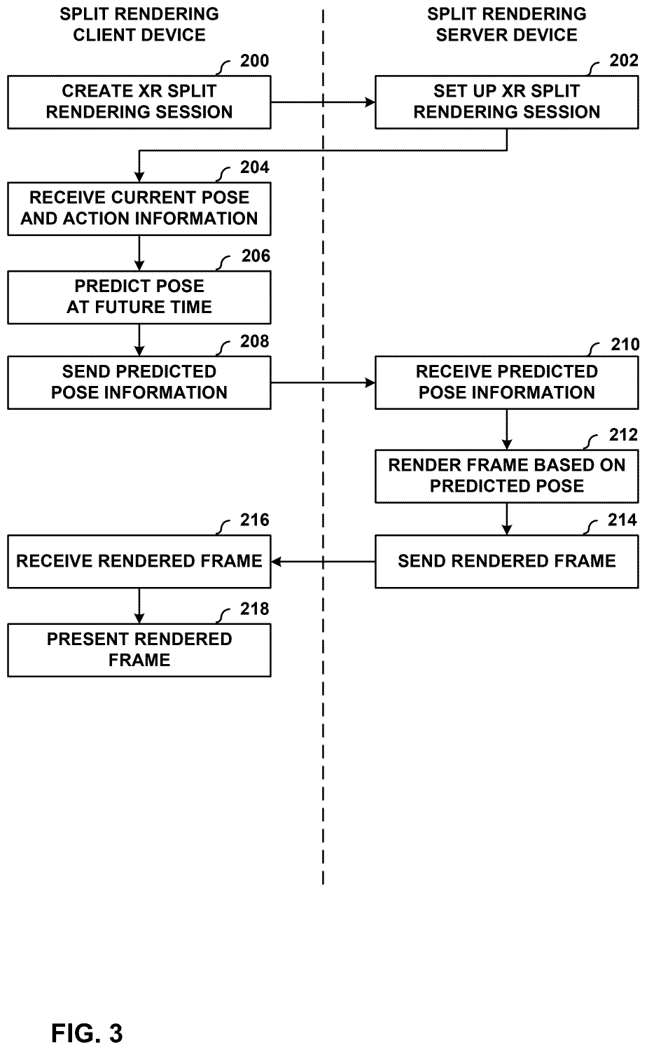

FIG. 3 is a flowchart illustrating an example method of performing split rendering according to techniques of this disclosure. The method of FIG. 20 is performed by a split rendering client device, such as XR client device 140 of FIG. 2, in conjunction with a split rendering server device, such as XR server device 110 of FIG. 2.

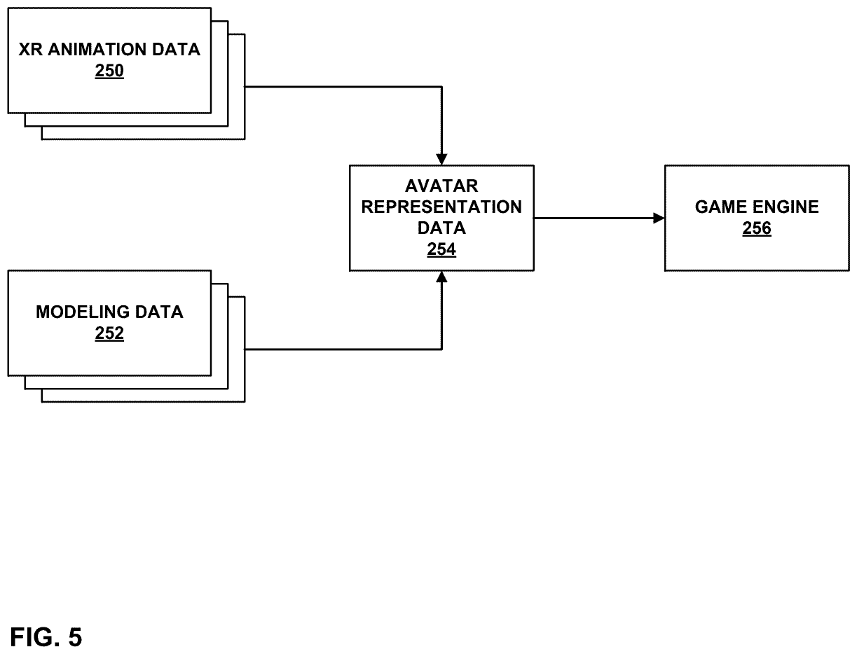

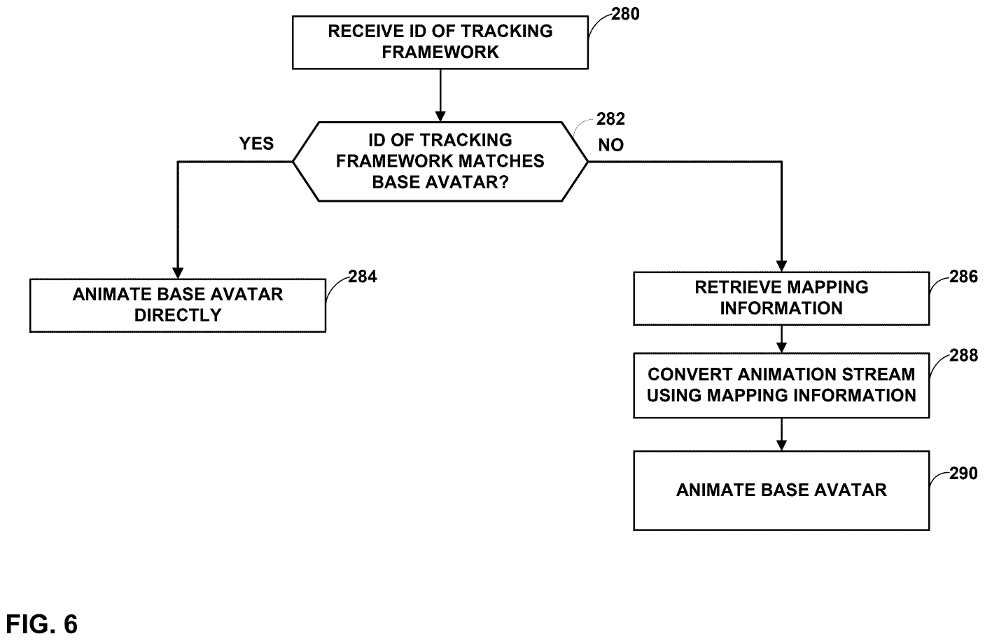

Initially, the split rendering client device creates an AR split rendering session (200). Creating the AR split rendering session may include any or all of steps 200-208 of FIG. 5, and/or steps 220 and 224 of FIG. 6. As discussed above, creating the AR split rendering session may include, for example, sending device information and capabilities, such as supported decoders, viewport information (e.g., resolution, size, etc.), or the like. The split rendering server device sets up an AR split rendering session (202), which may include setting up encoders corresponding to the decoders and renderers corresponding to the viewport supported by the split rendering client device.

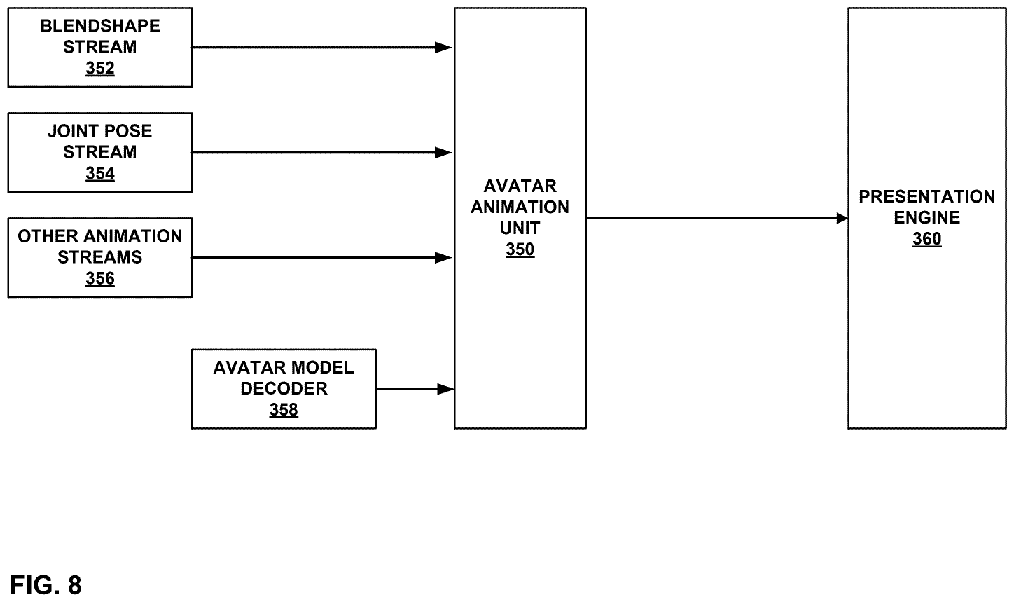

The split rendering client device may then receive current pose and action information (204). For example, the split rendering client device may collect AR pose and movement information from tracking/XR sensors (e.g., tracking/XR sensors 146 of FIG. 2). The split rendering client device may then predict a user pose (e.g., position and orientation) at a future time (206). The split rendering client device may predict the user pose according to a current position and orientation, velocity, and/or angular velocity of the user/a head mounted display (HMD) worn by the user. The predicted pose may include a position in an AR scene, which may be represented as an {X, Y, Z} triplet value, and an orientation/rotation, which may be represented as an {RX, RY, RZ, RW} quaternion value. The split rendering client device may send the predicted pose information, (optionally) along with any actions performed by the user to the split rendering server device (208). For example, the split rendering client device may form a message according to the format shown in FIG. 8 to indicate the position, rotation, timestamp (indicative of a time for which the pose information was predicted), and optional action information, and send the message to the split rendering server device.

The split rendering server device may receive the predicted pose information (210) from the split rendering client device. The split rendering server device may then render a frame for the future time based on the predicted pose at that future time (212). For example, the split rendering server device may execute a game engine that uses the predicted pose at the future time to render an image for the corresponding viewport, e.g., based on positions of virtual objects in the AR scene relative to the position and orientation of the user's pose at the future time. The split rendering server device may then send the rendered frame to the split rendering client device (214).

The split rendering client device may then receive the rendered frame (216) and present the rendered frame at the future time (218). For example, the split rendering client device may receive a stream of rendered frames and store the received rendered frames to a frame buffer. At a current display time, the split rendering client device may determine the current display time and then retrieve one of the rendered frames from the buffer having a presentation time that is closest to the current display time.

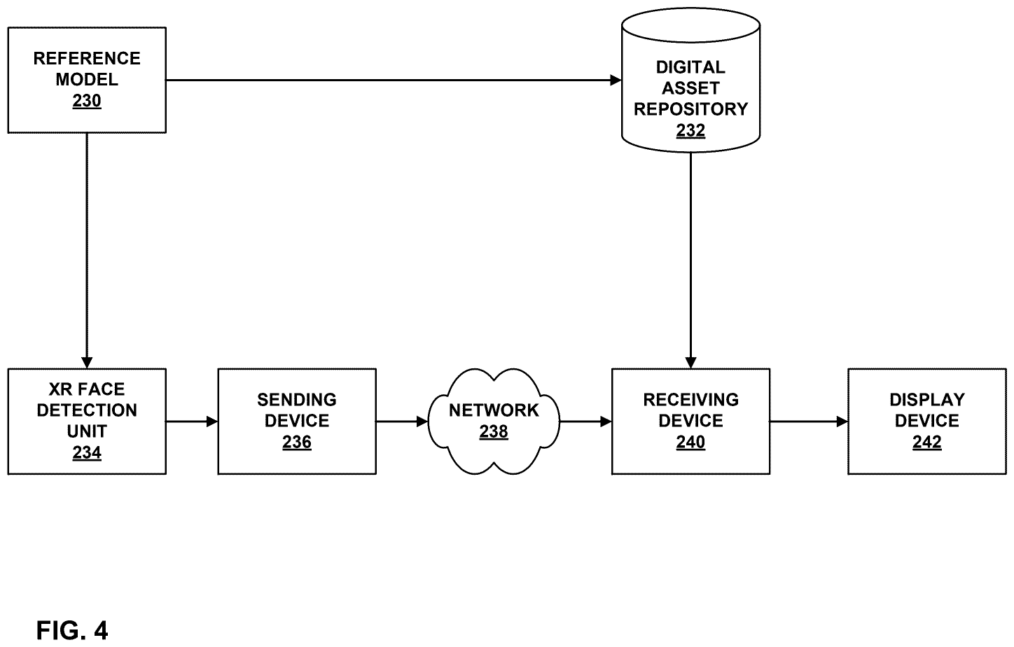

FIG. 4 is a block diagram illustrating an example set of devices that may perform various aspects of the techniques of this disclosure. The example of FIG. 4 depicts reference model 230, digital asset repository 232, XR face detection unit 234, sending device 236, network 238, receiving device 240, and display device 242.

Sending device 236 may correspond to UE 12 of FIG. 1, and receiving device 240 may correspond to UE 14 of FIG. 1 and/or XR client device 140 of FIG. 2.

Sending device 236 and receiving device 240 may represent user equipment (UE) devices, such as smartphones, tablets, laptop computers, personal computers, or the like. XR face detection unit 234 may be included in an XR display device, such as an XR headset, which may be communicatively coupled to sending device 236.

Likewise, display device 242 may be an XR display device, such as an XR headset.

In this example, reference model 230 includes model data for a human body and face. Digital asset repository 232 may include avatar data for a user, e.g., a user of sending device 236. Digital asset repository 232 may store the avatar data in a base avatar format. The base avatar format may differ based on software used to form the base avatar, e.g., modeling software from various vendors.

XR face detection unit 234 may detect facial expressions of a user and provide data representative of the facial expressions to sending device 236. Sending device 236 may encode the facial expression data and send the encoded facial expression data to receiving device 240 via network 238. Network 238 may represent the Internet or a private network (e.g., a VPN). Receiving device 240 may decode and reconstruct the facial expression data and use the facial expression data to animate the avatar of the user of sending device 236.

Various facial and body tracking units may perform facial and body tracking in different ways, which may vary widely according to a solution being sought. For example, various facial and body tracking units may be configured with different numbers of blendshapes with different sets of expressions and/or different rigs (that is, 3D models of joints and bones) with different sets of bones and joints and different bone dimension. Some facial expressions and bones/joints do not exist in certain solutions but do exist in other solutions.

This variation in 3D object model representations can lead to interoperability challenges. For example, sending device 236 may use a first framework to track face and body movements of a user, while receiving device 240 may use a base avatar of the user of sending device 236 that is based on a different set of facial expressions and body skeleton. This disclosure describes techniques for enabling avatar animation when different tracking frameworks are used for the base model and movement tracking.

The MPEG Avatar Representation Format (ARF) standard focuses specifically on two key components of an avatar animation system: the Base Avatar Format and the Animation Stream Format. These standardized formats form the core scope of the standard, enabling interoperable avatar animation across different implementations.

The Base Avatar Format establishes the standardized representation for avatar models, which can then be stored in a digital asset repository, ensuring that the fundamental avatar assets can be reliably accessed and animated by the receiving entity.

The Animation Stream Format defines how animation data should be structured and transmitted between senders and receivers. This format standardizes the way facial and body animation information is encoded, allowing data captured from input devices like VR headsets and sensors to be consistently interpreted across different systems for the animation of associated avatars.

FIG. 5 is a conceptual diagram illustrating an example set of data that may be used in an AR session per techniques of this disclosure. In this example, FIG. 5 depicts XR animation data 250, modeling data 252, avatar representation data 254, and game engine 256. Modeling data 252 may represent one or more sets of data used to form a base avatar model, which may originate from various sources, such as modeling software (e.g., Blender or Maya), glTF, universal scene description (USD), VRM Consortium, MetaHuman, or the like. XR animation data 250 may represent one or more tracked movements of a user to be used to animate the base model, which may originate from OpenXR, ARKit, MediaPipe, or the like. The combination of the base model and the animation data may be formed into avatar representation data 254, which game engine 256 may use to display an animated avatar. Game engine 256 may represent Unreal Engine, Unity Engine, Godot Engine, 3GPP, or the like.

FIG. 6 is a flowchart illustrating a method of animating a base avatar according to a framework for the base avatar and a tracking framework per the techniques of this disclosure. The method of FIG. 6 is explained with respect to the devices of FIG. 4 for purposes of example and explanation.

Initially, sending device 236 may signal an identifier (ID) of a tracking framework used to track movements of the user, such as body, hand, and facial movements. Thus, receiving device 240 may receive the ID of the tracking framework (280). Receiving device 240 may then determine whether the ID of the tracking framework matches a framework for the base avatar (282). If the ID of the tracking framework matches the framework for the base avatar (“YES” branch of 282), then receiving device 240 may animate the base avatar using received movement data directly (284).

However, if the ID of the tracking framework does not match the framework for the base avatar (“NO” branch of 282), then receiving device 240 may retrieve mapping information (286) that defines a mapping between the animation stream framework of sending device 236 and the framework of the base avatar model. Receiving device 240 may then convert received animation stream data using the mapping information (288) and animate the base avatar using the converted animation stream data (290). In this manner, receiving device 240 may use the mapping information to animate the base avatar model.

In some examples, a server device or other device may host a registry of tracking framework identifiers to be used by receiving devices of AR communication sessions for this purpose. Additionally or alternatively, a globally unique and self-assigned identifier, such as a uniform resource name (URN), may be used. For example: urn:mpeg:avatar:v1:animation-facial and animation-body may be used. Using different identifiers for facial and body animation may allow for using different frameworks for tracking the face and the body of the user.

The identifier may uniquely identify characteristics such as face blendshapes and corresponding facial expressions, e.g., as an ordered list. For example, blendshape 1 may represent “left eyebrow lowered.” The identifier may also uniquely identify body joints and their hierarchy as an enumerated list, e.g., “joint 1” may correspond to the hips. The identifiers may be directly derived from OpenXR extension names. For example, “urn:khronos:openxr:fb:face-tracking:v1” may refer to the XR_FB_face_tracking extension to OpenXR for face tracking.

In some examples, the mapping data may be a matrix that is stored as a document. Rows of the matrix may represent animation stream parameters for the tracking framework, while columns of the matrix may represent parameters that are used by the base avatar model. Coefficients of any raw data may be values between [0, 1] inclusive. Also, for any raw value i, the following requirement may be satisfied:

$${{\sum }_{j = 1}}^{m} {c}_{i , j} \leq 1$$

For information that is not mappable, coefficients may be set to 0.0

Animations may be performed based on the mapping table. For facial animation, blendshape weights from the tracking framework may be mapped using the following pseudocode. A normalization or clipping operation may be applied at the end to ensure that no weight value exceeds 1.0:

```
assume M as the (n,m) mapping matrix
where n is the number of coefficients in the animation stream
and m is the number of blendshapes in the base avatar model
output = input * M
for j in range(1,m)
  if normalize, output_j = output_j / sum(M_j) # normalization
  else, output_j = min(output_j, 1.0) # clipping
```

In the pseudocode above, M represents the mapping matrix discussed above. The value ‘n’ represents the number of coefficients in the animation stream and the value ‘m’ represents the number of blendshapes in the base avatar model. The matrix M is used to map an input value “input” to an output value “output.” Then for each value j between 1 and m, if the value is to be normalized, then the output value is divided by the sum of the values from the matrix for j; otherwise, the lesser of the output value and 1.0 is output.

For body animations, tracking information may provide joint locations for all joints that are supported by the tracking framework. The mapping table may include a pair of {4×4 transform matrix, weight} for each input joint i output joint j. The sum of the weights may be as close to 1.0 as possible. One input joint may influence multiple output joints, and one output joint may be influenced by multiple input joints. The mapping may be performed before applying the skinning transform. An example equation is as follows:

$${Pose}_{j} = {{\sum }_{i = 1}}^{n} {w}_{i , j} * {T}_{i , j} * {Pose}_{i}$$

The mapping document may be formatted as a JSON document. The mapping document may include an information section, a facial section, a body section, and a hand section. The information section may contain identifiers of input and output animation data frameworks. The information section may also contain available mappings, e.g., facial, body, hand, and their corresponding number of input (N) and output (M) parameters. For example, the information section may indicate that there are 70 input blendshapes and 52 output blendshapes. The facial section may contain the mapping matrix for the facial blendshapes. The body and hand sections may contain respective NxM weight matrices and N×M matrixes of 4×4 transform matrices. A mapping document may be identified by a dedicated MIME type. For example, such a MIME type may be, “application/json+avatar-animation-mapping.”

As an alternative, the mapping table may be defined as a non-linear function through the usage of pre-trained and fine-tuned neural networks. The document may contain pointers to the DNN model for each section (facial, body, hand, and so on). The input parameters may be fed into the DNN, which produces the output parameters corresponding to the framework used by the base avatar model.

In this manner, the techniques of this disclosure may be used by an apparatus to enable cross-tracking framework animation of avatars. Likewise, the techniques of this disclosure include mapping data, which may be a table or DNN model, that is used to convert input animation stream data to output animation data that can be used with a base avatar model.

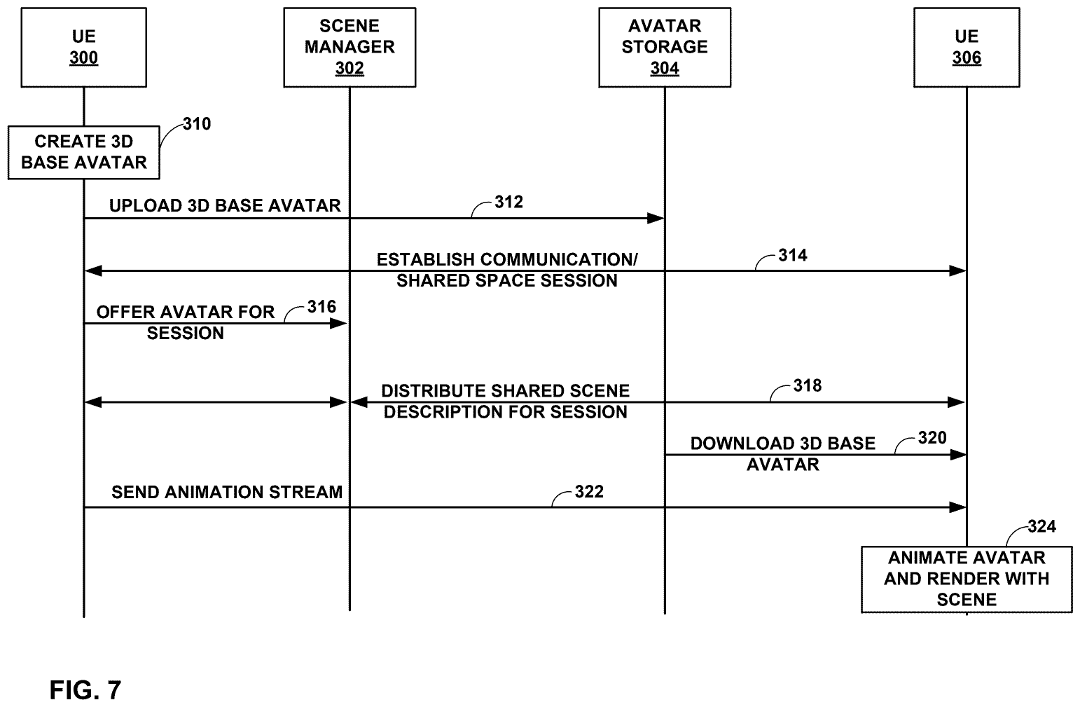

FIG. 7 is a flow diagram illustrating an example method for exchanging avatar data for a communications session. MPEG Avatar Representation Format (ARF) is a representation for 3D animatable avatars. MPEG ARF provides an exchange format that allows users to capture 3D avatars once and import the avatars for use anywhere across applications, platforms, and Metaverse worlds. MPEG ARF also provides a standardized interoperable storage and exchange animation format that applications and services can build on. MPEG ARF includes two components: a base avatar container and animation streams. The base avatar container is a container that stores user avatar components, such as meshes, texture maps, skeletons, blendshapes, garments, and other digital assets. Animation stream are formatted according to MPEG ARF and used to animate the base avatar model in the container. Body animation may be performed using linear blend skinning and facial expressions through blendshapes.

MPEG ARF enables the realization of avatar-based communication and other shared experiences. A receiving device may start by downloading the base avatar model of a sending device at the beginning of a session, then use a received animation stream to continuously animate and render the avatar of the sending device. For example, FIG. 7 depicts UE 300 (a sending UE in this example), scene manager 302, avatar storage 304, and UE 306 (a receiving UE in this example).

In this example, UE 300 is used to create a 3D base avatar for a user thereof (310). UE 300 then uploads the 3D base avatar to avatar storage 304 (e.g., a network server device). In order to use avatars in communication and shared experience sessions, a user may generate and upload their base avatar model. The use may use local or cloud-based avatar generation tools and services to create a personalized avatar base model. The user may upload the base avatar model to a central accessible storage server (avatar storage 304) that will offer download of that user's base avatar model to authorized users.

Later, UE 306 and UE 300 establish (or join) a communication session or other shared virtual space session (314), e.g., an AR media communication session. In this example, UE 300 offers the 3D base avatar for use during the communication session (316). UE 300 may send data indicating that the 3D base avatar can be used for the virtual session to scene manager 302. Scene manager 302 then forms a scene description for the AR media communication session and sends the scene description to UE 300 and UE 306 (318). In particular, scene manager 302 may add a node into the scene description that contains a description of how the base model for UE 300 can be reconstructed and animated by other participants in the AR media communication session.

UE 306 then determines that the 3D base avatar is available from avatar storage 304 from the scene description. The scene description may also include authorization data, such as an authorization token or other authorization data, to be sent to avatar storage 304 to retrieve the 3D base avatar. UE 300 may also restrict certain digital assets of the 3D base avatar, such that only certain assets are available to UE 306 (e.g., specific assets and/or specific levels of detail). Thus, UE 306 may download the 3D base avatar (320) from avatar storage 304. UE 300 may also send an animation stream to UE 306 (322) during the AR media communication session. UE 306 may then use data of the animation stream to animate and render the avatar with the 3D scene (324).

FIG. 8 is a block diagram illustrating an example animation system for 3D models. In this example, avatar animation unit 350 receives blendshape stream 352 (which may include facial blendshapes), joint pose stream 354, and other animation streams 356. Avatar animation unit 350 also receives a decoded 3D base avatar model from avatar model decoder 358. Avatar animation unit 350 then animates the decoded 3D base avatar model based on the various animation streams and provides the animation data to presentation engine 360. Presentation engine 360 then renders the animated avatar in the 3D scene and presents the animated avatar and the 3D scene.

The avatar pipeline is generally responsible for retrieving, reconstructing, and animating the avatar representation of the remote user and then populating this information into the internal scene graph representation based on the information in the scene description document.

The avatar pipeline may first be initialized using information about the format and location of the base avatar model and the animation streams. The avatar pipeline may instantiate all the necessary components to decode, decrypt, and animate the base avatar model based on that description. The base avatar model may be downloaded, and avatar model decoder 358 may decode/decrypt the 3D base avatar model, making the avatar ready for animation. Avatar animation unit 350 may receive and decode timed animation data (in the form of one or more animation streams) and use the animation data to animate the base avatar model. Avatar animation unit 350 may provide the reconstructed/animated 3D avatar model to presentation engine 360 for rendering, typically as a dynamic mesh, according to the description provided by the scene description document.

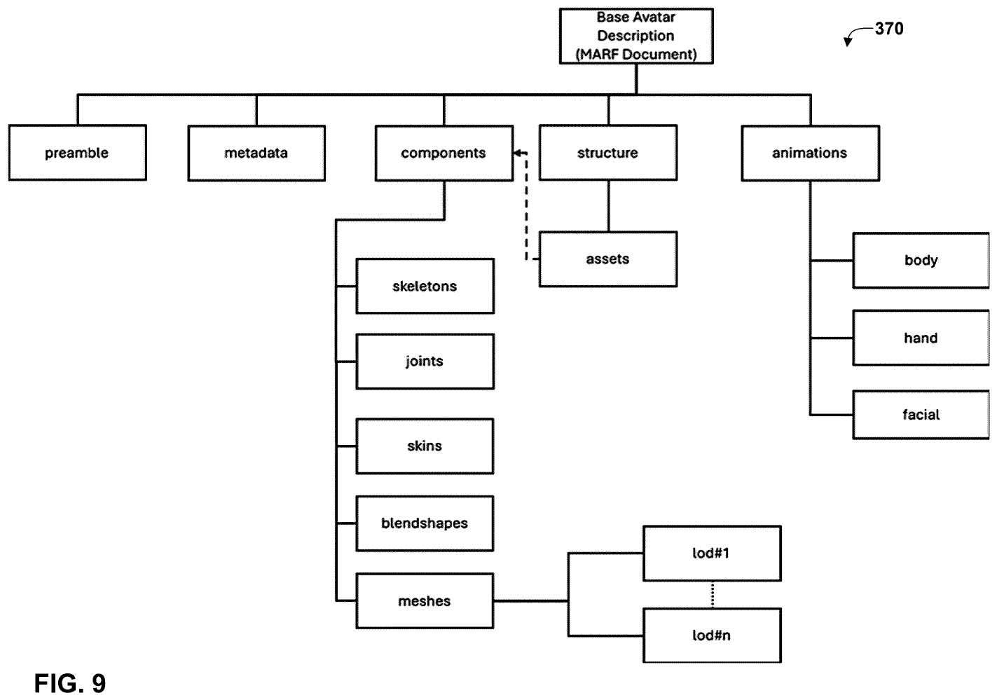

FIG. 9 is a graph 370 representing an example set of components of a base avatar description, also referred to as an MPEG Avatar Representation Format (MARF) document. The MARF document may include, for example, a preamble, metadata, a set of components, a structure including data representing assets, and a set of animations.

The components of the avatar may include, for example, skeletons, joints, skins, blendshapes, and meshes, and each mesh may be represented by one or more levels of detail (LODs). The animations may include body, hand, and/or facial animations.

The MARF document may be formatted as a JavaScript Object Notation (JSON) document. The MARF document may describe the user's base avatar model. The MARF document may act as an entry point to the base avatar model. The MARF document may list available components of and assets of the base avatar model and relationships between the components and assets.

The preamble of the MARF document may uniquely identify the format and characteristics of the MPEG Avatar Representation Format. The preamble may carry a unique signature and information about compatible animation frameworks for the corresponding base avatar model. The preamble may conform to the following format:

| Object/property name | | Type | Use | Description |
|---|---|---|---|---|
| preamble | | object | M | Contains data that |
| | | | | uniquely identifies the |
| | | | | format and |
| | | | | characteristics of the |
| | | | | MPEG Avatar |
| | | | | Representation Format. |
| signature | | string | M | Uniquely identifies the |
| | | | | MPEG Avatar |
| | | | | Representation Format. |
| version | | string | M | Specifies the version of |
| | | | | the MPEG Avatar |
| | | | | Representation Format. |
| authentication_features | | array | O | An array of features that |
| | | (object) | | are used to identify the |
| | | | | owner of this base avatar. |
| | | | | The usage of this |
| | | | | information is described |
| | | | | in Annex A. |
| | public_key | URI | M | A URL to the public key |
| | | | | that is used to decrypt the |
| | | | | features. |
| | facial_feature | string | O | A base64 encoded |
| | | | | feature vector of floats. |
| | | | | This can be used to |
| | | | | match extracted facial |
| | | | | features during a |
| | | | | communication session. |
| | | | | The facial feature shall |
| | | | | be encoded with the |
| | | | | user's private key to |
| | | | | preserve authenticity. |
| | voice_feature | string | O | A base64 encoded |

| | | | |
|---|---|---|---|
| | | | feature vector of floats. |
| | | | This can be used to |
| | | | match extracted voice |
| | | | features during a |
| | | | communication session. |
| | | | The voice feature shall |
| | | | be encoded with the |
| | | | user's private key to |
| | | | preserve authenticity. |
| supportedAnimation | object | M | Contains information |
| | | | about the supported |
| | | | animation types. |
| faceAnimation | array(uri) | M | Lists the supported face |
| | | | animation types. Each |
| | | | item in the array is a |
| | | | string representing a |
| | | | supported face animation |
| | | | type. |
| | | | Each identifier should be |
| | | | formatted as a URN that |
| | | | includes an identifier of |
| | | | the framework, followed |
| | | | by an identifier of the |
| | | | facial blendshape set. An |
| | | | example is: |
| | | | “urn:khronos:openxr:facial- |
| | | | animation:fb- |
| | | | tracking2”. |
| bodyAnimation | array(uri) | M | Lists the supported body |
| | | | animation types. Each |
| | | | item in the array is a |
| | | | string representing a |
| | | | supported body |
| | | | animation type. |
| | | | Each identifier should be |
| | | | formatted as a URN that |
| | | | includes an identifier of |
| | | | the body |
| | | | animation/tracking |
| | | | framework, followed by |
| | | | an identifier of the body |
| | | | joint set. An example is: |
| | | | “urn:khronos:openxr:body- |
| | | | animation:fb-body”. |
| handAnimation | array(uri) | M | Lists the supported hand |
| | | | animation types. Each |
| | | | item in the array is a |
| | | | string representing a |
| | | | supported hand |
| | | | animation type. |
| | | | Each identifier should be |
| | | | formatted as a URN that |
| | | | includes an identifier of |
| | | | the body |
| | | | animation/tracking |
| | | | framework, followed by |
| | | | an identifier of the body |
| | | | joint set. An example is: |
| | | | “urn:khronos:openxr:hand- |
| | | | animation:hand”. |

The metadata component of the MARF document may contain information about the user who owns the base avatar model, physical characteristics of the base avatar (e.g., gender, age, and height), as well as other metadata related to security and protection of the base avatar model. The metadata component may conform to the following format:

| Object or | | | |
|---|---|---|---|
| Property Name | Type | Use | Description |
| metadata | object | M | this object carries metadata related |
| | | | to the base avatar model. |
| personal | object | M | specifies personal metadata |
| | | | information. |
| | | | To be replaced by a standardized |
| | | | type for personal information |
| name | string | M | specifies the name of the user who |
| | | | owns this base avatar model. |
| age | number | O | specifies the age of the user. |
| gender | MPEG_{—} | O | specifies the gender of the avatar. |
| | AVATAR_{—} | | Possible values are: |
| | GENDER | | “GENDER_FEMALE”, |
| | | | “GENDER_MALE”, |
| | | | “GENDER_NEUTRAL” |

The structure object of the MARF document may describe the structure of the MARF container. The structure object may list assets and levels of detail included in the MARF container. The structure object may also provide information about any encryption scheme(s) needed to decrypt the components of the MARF container that are encrypted. The structure object may conform to the following format:

| Object/Property | | | |
|---|---|---|---|
| Name | Type | Use | Description |
| structure | object | M | Contains data related to the |
| | | | structure of the MARF |
| | | | container. |
| lods | number | M | Specifies the levels of detail |
| | | | included in this MARF |
| | | | container. |
| assets | array | M | Lists the assets included in |
| | | | this MARF container. |
| name | string | M | The name of the asset. |
| type | ASSET_{—} | M | The type of the asset. The |
| | TYPE | | following types are |
| | | | supported: |
| | | | BODY |
| | | | HEAD |
| | | | HAND |
| | | | ACCESSORY |
| | | | This list is extensible and |
| | | | may be extended in future |
| | | | versions of this specification. |
| skeleton | number | O | The id of the skeleton |
| | | | associated with this asset. |
| blendshape_set | number | O | The id of the blendshape set |
| | | | associated with the asset. |
| skin | number | O | The skin associated with the |
| | | | asset. |
| meshes | array(number) | M | An array of identifiers of the |
| | | | meshes that build this asset. |
| protection | object | M | Contains information about |
| | | | the encryption scheme used |
| | | | to protect the MARF |
| | | | container. |
| schemeId | string | M | The identifier of the |
| | | | encryption scheme. |
| schemeInfoData | string | M | Additional information about |
| | | | the encryption scheme. |

The components object is the core of the MARF document and lists components of the MARF container. The components object provides information to access and use the components for the reconstruction and animation of the base avatar model. The components object may conform to the following format:

| Object/Property Name | Type | Use | Description |
|---|---|---|---|
| components | object | M | The core of the MARF |
| | | | document, listing all |
| | | | components of the |
| | | | MARF container. |

| | | | |
|---|---|---|---|
| skeletons | array | M | Contains a list of |

| | (object) | | skeletons, each with a |
|---|---|---|---|
| | | | name and set of joints. |
| name | string | M | The name of the |
| | | | skeleton. |
| joints | array | M | Contains a list of joint |

| | | | ids. |
|---|---|---|---|
| | | | A skeleton may be a |
| | | | subset of a full |
| | | | humanoid skeleton, |
| | | | e.g. just by referencing |
| | | | the head and hand |
| | | | joints. |
| skins | array | M | Contains a list of |

| | (object) | | skins, each with a |
|---|---|---|---|
| | | | name and the skinned |
| | | | meshes associated with |
| | | | it. |
| name | string | M | The name of the skin. |
| skinnedMeshes | array | M | An array of numbers |

| | | | representing the IDs of |
|---|---|---|---|
| | | | the meshes associated |
| | | | with this skin. |
| blendshapes | array | M | Contains a list of |

| | (object) | | blendshape sets, each |
|---|---|---|---|
| | | | with a basis mesh, |
| | | | encoding, and shapes. |
| basisMesh | number | M | The ID of the mesh |
| | | | that the blendshapes |
| | | | are based on. |
| encoding | string | M | The encoding used for |
| | | | the blendshapes. |
| shapes | array | M | Contains a list of |

| | | | shapes, each with an |
|---|---|---|---|
| | | | ID, name, and the ID |
| | | | of the mesh |
| | | | representing the shape. |
| joints | array | M | contains a list of joints, |

| | (object) | | each with an ID, name, |
|---|---|---|---|
| | | | parent joint ID, |
| | | | transform matrix, and |
| | | | an optional inverse |
| | | | bind matrix. |
| id | number | M | a unique identifier of |
| | | | this joint in the MARF |
| | | | container. |
| name | string | M | a name assigned to the |
| | | | joint. |
| parent | number | O | if present, the id of the |
| | | | parent joint of this |
| | | | joint. The root joint |
| | | | shall not have an |
| | | | assigned parent. |
| transform | array | M | Provides the 4 × 4 |
| | (number) | | transform matrix for |
| | | | the joint to define the |
| | | | position and |
| | | | orientation of the joint |
| | | | at rest pose. |
| inverseBindMatrix | array | O | provides the inverse |

| | (number) | | bind matrix for this |
|---|---|---|---|
| | | | joint. If present the |
| | | | location of the joint |
| | | | shall be adjusted by |
| | | | multiplying with the |
| | | | inverse bind matrix. |
| meshes | array | M | Contains a list of |

| | | | meshes, each with an |
|---|---|---|---|
| | | | ID, skinned status, |
| | | | levels of detail |
| | | | (LODs), and a name. |
| id | number | M | The ID of the mesh. |
| name | string | M | The name of the mesh. |
| skinned | boolean | M | Indicates whether the |
| | | | mesh is skinned (true) |
| | | | or not (false). |
| lods | array | M | Contains a list of |

| | | | |
|---|---|---|---|
| | | | LODs, each with LOD |
| | | | number, MIME type, |
| | | | location, embedded |
| | | | weights status, joint |
| | | | weights, and |
| | | | protection information. |
| lod_id | number | M | the number identifying |
| | | | the LoD with which |
| | | | this representation is |
| | | | associated. |
| mime | string | M | The MIME type that |
| | | | identifies the format of |
| | | | the mesh. In this |
| | | | version of the |
| | | | specification, it shall |
| | | | be set to “model/gltf- |
| | | | binary”. |
| location | URI | M | location of the LoD |
| | | | representation of this |
| | | | mesh. In this version |
| | | | of the specification, |
| | | | this shall be a pointer |
| | | | to a GLB file. |
| embedded_weights | boolean | O | Indicates whether the |
| | | | mesh also comes with |
| | | | the LBS weights for |
| | | | each vertex, associated |
| | | | with the identified |
| | | | joint sets. The default |
| | | | value is false. If set to |
| | | | true, the author needs |
| | | | to ensure that the |
| | | | embedded joint set |
| | | | also matches the one |
| | | | associated with this |
| | | | skinned mesh. |
| | | | This element shall not |
| | | | be present if “skinned” |
| | | | is set to false. |
| joint_weights | URI | O | A link to the location |
| | | | of a binary file that |
| | | | provides a list of joint |
| | | | ids and associated LBS |
| | | | weights for every |
| | | | vertex in this LoD |
| | | | mesh representation. |
| | | | This element shall not |
| | | | be present if “skinned” |
| | | | is set to false. |
| compression | string | O | an identifier of the |
| | | | compressor used to |
| | | | compress this LoD |
| | | | representation of the |
| | | | mesh. |
| protection | id | O | An identifier of the |
| | | | protection |
| | | | configuration that is |
| | | | applied to encrypt this |
| | | | LoD representation of |
| | | | the mesh. |

| | | | |
|---|---|---|---|
| proprietary_animation | object | O | This object may |

| | | | provide information |
|---|---|---|---|
| | | | about an ML-based |
| | | | proprietary model for |
| | | | reconstruction and |
| | | | animation of the user's |
| | | | avatar. |
| scheme | URI | M | A vendor-specific |
| | | | URN to identify the |
| | | | proprietary |
| | | | reconstruction and |
| | | | animation scheme. |
| items | array(uri) | M | A list of the items, e.g. |

pretrained models or
model weights, that are
used by this
proprietary
reconstruction and
animation scheme.

The MARF container is generally designed to facilitate efficient and flexible avatar representation and transmission in communication and shared space sessions. The MARF container may act as a structured repository for all the elements that constitute the user's base avatar model, thus enabling seamless integration and animation across platforms and applications.

The MARF document may be marked as the entry point to the MARF container. The MARF document may describe all the components that make up the user's base avatar model. All components that are described by the MARF document may be stored in the MARF container and the addressing scheme may allow for locating these components within the MARF container.

A feature of the MARF container format is its support for partial access. This means that, depending on the specific requirements of the application or on the network conditions, only a subset of the user's base avatar components need to be downloaded. The selection of the components may be based on factors like the desired level of detail (LoD), the target bitrate, and the user's selection (e.g. the skinned meshes that represent garments).

The MARF container format may enable real-time avatar-based communication and shared experiences. By providing a standardized and interoperable way to store and transmit avatar data, the MARF container may streamline the process of sharing and animating avatars across different platforms and applications. In a typical scenario, a user would first create and upload their base avatar model to a central server. When participating in a communication or shared experience session, the user's avatar information, including the location of the MARF container, is shared with other participants. Based on the received information and the negotiated access level, the other participants can then download the container with only the necessary/authorized components of the user's avatar and animate it in real time using the transmitted animation streams.

Two example MARF container formats for storage of a user's base avatar model are described below. The first example is ISOBMFF-based, and the second is Zip-based.

An example ISOBMFF-based container format for the MARF container may use the following brands in a FileTypeBox:

| Brand | Description | Compatibility Level |
|---|---|---|
| marf | file level non-timed | every ISOBMFF-based container shall |
| | metadata items | declare marf as the major brand. |
| maas | marf + timed | Files that contain stored animation |
| | animation streams | streams shall declare maas among their |
| | | compatibility brands. |

When stored in an ISOBMFF-based container, the user's base model may be stored as metadata items, with the MetaBox being declared at the file level. A PrimaryItemBox may be present and contain the item identifier of the item that contains the MARF document.

The HandlerBox may have a handler_type set to ‘marf’. The primary item may declare content_type of “model/marf+json”. The primary item may contain an item protection box that defines the encryption for the components of the base avatar model that are protected. Each component of the base avatar model, including the different LoD variants, may be stored as respective independent items.

When animation streams are also stored as part of the MARF container, at least one metadata track may be present in the file and carry the avatar animation samples. A ‘meta’ handler type may be used in the HandlerBox of the MediaBox. The sample entry format may be ‘urim’. Independent animation samples may be marked as sync samples. The URI identifying the type of the metadata may be ‘urn:mpeg:avatar:animation’.

Samples may be grouped to indicate a sequence of associated animation codes that are stored and ready for playback. The sample group may be signaled using the group type ‘aasq’. Each animation sample group may have a description about the pre-stored animation sequence, e.g. “smile” or “dance”.

Another example MARF format may be Zip-based. A Zip container may be formatted according to ISO/IEC 21320-1. All components of the base avatar model may be included in the Zip file. The references to these components may be relative to the location of the MARF document. The MARF document may be in the root folder of the Zip container and named “marf.json”.

If present, animation sequences may be stored as individual binary files with file extension “.bin” under a folder named “animations”. The format of each of these animation files may be as follows:

| | Descriptor |
|---|---|
| animation_file( ) { | |
| num_animation_sequences | int(16) |
| for(i=0;i<num_animation_sequences;i++) { | |
| num_chars_in_description | int(16) |
| description[num_chars_in_description] | b(8) |
| num_facial_animations | int(16) |
| for(j=0;j<num_facial_animations;j++) { | |
| facial_animation_sample | See clause 6 |
| } | |
| num_body_animations | int(16) |
| for(j=0;j<num_facial_animations;j++) { | |
| body_animation_sample | See clause 6 |
| } | |
| num_hand_animations | int(16) |
| for(j=0;j<num_facial_animations;j++) { | |
| hand_animation_sample | See clause 6 |
| } | |
| } | |

MARF documents may support face, body, and hand animations. Facial animation may be performed through weighted blendshapes. Body and hand animations are performed through Linear Blend Skinning (LBS).

Linear blend skinning (LBS) is a technique that is used in 3D animation to deform a mesh, usually a humanoid character, based on the positions of its joints. Each vertex in the mesh may be assigned weights associated with a subset of the body joints. When a joint moves, the vertices associated with that joint are moved with the joint, each proportionally to the assigned weight for that joint. This creates a smooth and realistic-looking animation of the character. For every vertex, the weights assigned to the joints that impact its position should add up to 1.0 or a value very close to 1.0, to avoid artifacts in the animation.

The position of a vertex i may be determined using the set of bone transformations and their associated weights as described by the following equation:

$${v}_{{i}_{new}} = {{\sum }_{j = 1}}^{n} {w}_{i , j} * {M}_{global}^{j} * {v}_{i}$$

where M is the global transformation matrix for bone j, which is the cumulative product of the transformation matrices of all parent joints as well as the inverse bind matrix of bone j.

Facial blendshapes are a technique to animate a character's face, where facial expressions and deformations need to be captured with precision. A set of versions of the 3D mesh of the face/head is used, where each version represents a different facial expression (blendshape). By adjusting the weights that control the influence of each blendshape, the desired facial expression can be achieved.

Different facial expressions can be combined together to render a mixed expression according to the following formula:

$${v}_{out} = {v}_{0} + {{\sum }_{i = 1}}^{n} {w}_{i} * ( {v}_{i} - {v}_{0} )$$

In this equation, v₀ represents the position of the vertex in the basis mesh, which is the mesh at the neutral expression.

Blendshapes and joint animations may be carried in respective animation streams. An animation stream may be a timed sequence of animation samples, formatted according to animation stream formats. Example animation stream formats for blendshapes and joint animations are described below.

An example blendshape animation sample format is as follows:

| | Descriptor |
|---|---|
| blendshape_animation_sample( ) { | |
| timestamp | int(64) |
| blendshape_set_id | int(16) |
| confidence_present | int(1) |
| reserved | int(7) |
| num_blendshapes | int(16) |
| for(i=0;i<num_blendshapes;i++) { | |
| blendshape_id | int(16) |
| weight | float(32) |
| if (confidence_present) { | |
| confidence | float(32) |
| } | |
| } | |
| } | |

An example joint animation sample format is as follows:

| | Descriptor |
|---|---|
| joint_animation_sample( ) { | |
| timestamp | int(64) |
| joint_set_id | int(16) |
| velocity_present | int(1) |
| reserved | int(7) |
| num_joints | int(16) |
| for(i=0;i<num_joints;i++) { | |
| location_matrix[16] | float(32) |
| if (velocity_present) { | |
| velocity_matrix[16] | float(32) |
| } | |
| } | |
| } | |

The base avatar model may store mapping tables that assist the receiver with mapping between a natively supported blendshape or joint set and one that is provided by a face/body/hand tracking system and which can only be supported through conversion. A natively supported blendshape or joint set is one that matches the stored joint structure and set of blendshapes. An example of such a mapping is between the facial tracking framework accessible through the XR_FB_face_tracking2 extension of OpenXR and the blendshapes defined by the MPEG Morgan model.

A mapping may be stored as a separate component of the MARF container and as a JSON document with the following example format:

| Object/property name | | Type | Use | Description |
|---|---|---|---|---|
| animation_mapping | | object | M | Contains the necessary |
| | | | | information to map an |
| | | | | external tracking |
| | | | | information into the |
| | | | | one that is stored and |
| | | | | used base the base |
| | | | | avatar model to which |
| | | | | this document belongs. |
| | source_framework_id | uri | M | the identifier of the |
| | | | | input animation set to |
| | | | | which this mapping |
| | | | | applies. |
| | target_framework_id | uri | M | the identifier of the |
| | | | | target animation set to |
| | | | | which this mapping |
| | | | | applies. |
| | face_mappings | array | O | A array of facial |

| | (object) | | blenshape mappings. |
|---|---|---|---|
| blendshape_mapping | object | M | One instance of |

| | | | blendhsape mappings. |
|---|---|---|---|
| target_ | number | M | The identifier of the |
| blendshape_id | | | target blendshape. |
| contributing_ | array | M | An array of blendshape |
| blendshape_id | (number) | | ids from the source |
| | | | animation framework |
| | | | that contribute to this |
| | | | target blendshape. |
| weights | array | M | The associated weights |

| | (number) | | for the mapping of the |
|---|---|---|---|
| | | | contributing |
| | | | blendshapes into the |
| | | | target blendshape |
| | | | weight. The weights |
| | | | shall be provided in the |
| | | | same order as the |
| | | | contributing |
| | | | blendshape ids. |
| | | | The blendshape weight |
| | | | of the target |
| | | | blendshape is |
| | | | calculated as follows: |
| | | | ${W}_{target} = {\sum }_{i} {w}_{i} * {W}_{i}$ |
| joint_mappings | array | O | A list of mappings for |

| | (object) | | joints from the source |
|---|---|---|---|
| | | | framework to the target |
| | | | framework. |
| type | enumeration | M | body, hand |
| joint_mapping | object | M | An instance of a |

| | | mapping for a single |
|---|---|---|
| | | joint. |
| target_joint_id | number | The identifier of the |
| | | target joint. |
| contributing_ | array | A list of identifiers of |
| join_id | (number) | the contributing joints |
| | | to the target joint. |
| tranform_ | array | A list of weights |
| matrices | (number[16]) | associated with the |

contribution joint list.
The transform matrix
of the target joint shall
be calculated as:
${T}_{target} = {\sum }_{i} {w}_{i} * {T}_{i}$

An example JSON schema for the MARF document is as follows:

MARF is designed to work with the MPEG Scene Description (MPEG SD) solution based on glTF per ISO/IEC 23090-14. However, MARF is not limited to MPEG SD, and can be integrated in any scene description solution.

MPEG SD defines an MPEG_node_avatar extension that facilitates the integration of Avatars into the scene description. Per techniques of this disclosure, the avatar extension may be modified to enable a more proper MARF integration. For example, the following MPEG_Node_avatar extension may be as follows:

| | | | | |
|---|---|---|---|---|
| Name | Type | Usage | Default | Description |

| | | | |
|---|---|---|---|
| type | string | M | The type of the avatar |
| | | | representation is provided |
| | | | as a URN that uniquely |
| | | | identified the avatar |
| | | | representation scheme. |
| | | | The avatar representation |
| | | | scheme defines the format |
| | | | of all components that are |
| | | | used to reconstruct and |
| | | | animate the avatar. The |
| | | | reference MPEG avatar |
| | | | URN is defined in section |
| | | | 8.3.3. |
| | | | The MARF avatar format |
| | | | shall set this field to |
| | | | “mpeg:avatar:marf:2024” |
| mappings | array(Mapping) | M | The mapping between |
| | | | child nodes and their |
| | | | associated avatar path. |
| | | | Note that the |
| | | | corresponding path for a |
| | | | parent node shall be a |
| | | | prefix of the path of its |
| | | | child nodes. |
| reconstruction | object | O | An object that defines how |
| | | | the 3D Avatar is |
| | | | reconstructed and |
| | | | animated. |
| format | | M | The format field shall be |
| | | | set to “MARF”. |
| extras | object | O | Contains format-specific |
| | | | parameters that are used to |
| | | | initialize the Avatar |
| | | | pipeline. |
| | | | In this specification, The |
| | | | extras object shall contain |
| | | | the MARF-specific |
| | | | information as given |
| | | | below. |
| MARF_container | URI | M | The URL to the MARF |
| | | | container. |
| animation_streams | array(object) | M | An array of objects that |
| | | | each describes an |
| | | | animation stream |
| | | | associated with the base |
| | | | avatar model in |
| | | | MARF_container. |
| type | enumeration | M | The type of the animation |
| | | | stream. In this version of |
| | | | the specification, it shall |
| | | | be either |
| | | | “ANIMATION_{—} |
| | | | BLENDSHAPES” or |
| | | | “ANIMATION_JOINTS”. |
| source | number | M | A pointer to the accessor |
| | | | that contains the |
| | | | animation data. |

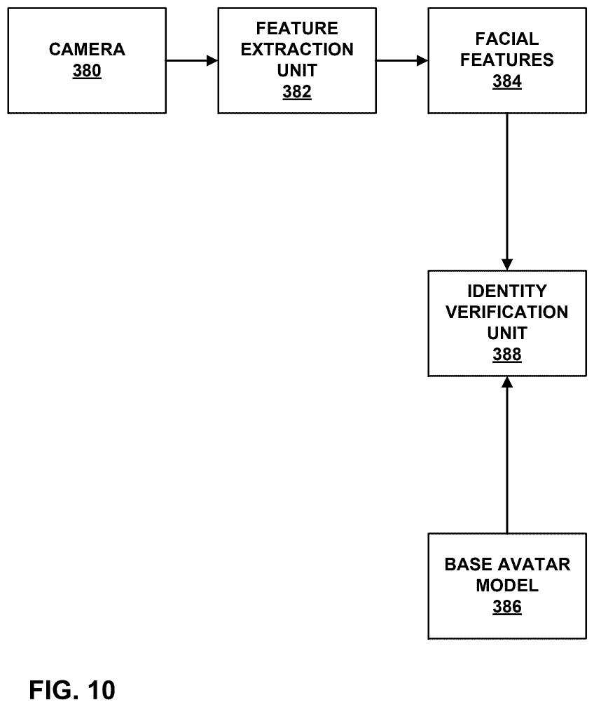

FIG. 10 is a block diagram illustrating an example system for ensuring that a base avatar model is used by a corresponding user who owns the base avatar model. In particular, the method of FIG. 10 may be used by an identity verification system to mitigate threats of deepfake impersonation in an avatar-based communication platform. These techniques may ensure that the individual offering the avatar is the legitimate owner of the associated base avatar model. This may be achieved by analyzing and comparing facial features and potentially other biometric markers extracted from the user's live audio-visual input (e.g., voice features) against those stored within a secure avatar container format.

In this example, the system includes camera 380, feature extraction unit 382, base avatar model 386, and identity verification unit 388. Camera 380 captures one or more images (which may include video data) of a user's face. Feature extraction unit 382 analyzes the images/video and/or audio stream to extract distinctive facial features 384 (and/or vocal features). Identity verification unit 388 compares facial features 384 to corresponding features stored within the user's avatar container of base avatar model 386. This comparison process may include using algorithms designed to tolerate natural variations in appearance due to lighting, expression, and/or aging.

If the comparison is successful, then base avatar model 386 may be presented during an AR media communication session. However, if the comparison is not successful, identity verification unit 388 may send an alert indicating a potential impersonation attempt.

Base avatar model 386 and the avatar container format may serve as a secure repository for a user's biometric data. The user's biometric features may be encrypted using the user's private key to ensure authenticity and allow all receivers to decode and extract the features using the user's corresponding public key.

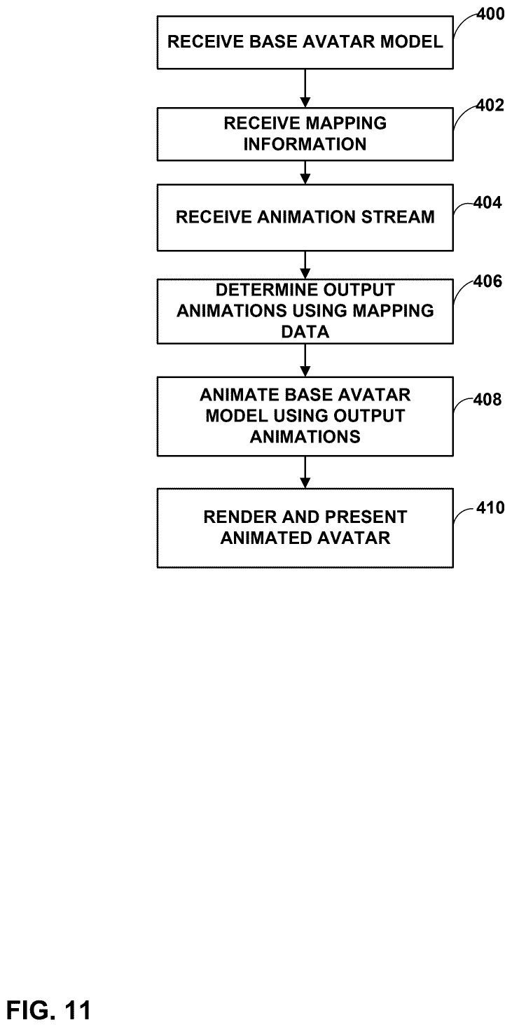

FIG. 11 is a flowchart illustrating an example method of using mapping data to determine animations to be used to animate a base avatar model in a supported framework when an animation stream includes animations expressed an unsupported framework, per techniques of this disclosure. For purposes of example and explanation, the method of FIG. 11 is explained with respect to receiving device 240 of FIG. 4. However, other devices, such as UEs 12, 14 of FIG. 1, XR client device 140 of FIG. 2, and/or UEs 300, 306 of FIG. 7, may also perform this or a similar method. The method of FIG. 11 may be performed as part of the method of FIG. 7.

Initially, receiving device 240 receives a base avatar model (400) of a user of a different device (e.g., sending device 236 of FIG. 4). Receiving device 240 may also receive mapping information (402) including data defining mappings between a first framework defining input animations of an AR media communication session and corresponding output animations of a second framework to be used to animate the base avatar model. The first framework may be, for example, a tracking framework used to track movements of the user of sending device 236. It is assumed that the tracking framework is not supported by the base avatar model. Therefore, movements expressed in the framework may be mapped to a second framework that is supported by the base avatar model in the mapping information.

Receiving device 240 may then receive an animation stream (404). The animation stream may be, for example, a blendshape stream, a joint animation stream, or the like. The animation stream may include time-based blendshapes and/or joint movements expressed in the first framework, which may be referred to as “input animations.” Therefore, receiving device 240 may determine output animations from the input animations using the mapping data (406). The output animations may correspond to animations expressed in the framework supported by the base avatar model.

Thus, receiving device 240 may then animate the base avatar model using the output animations (408). Receiving device 240 may further render and present the animated avatar (410).

In this manner, the method of FIG. 11 represents an example of a method of communicating augmented reality (AR) media data including: receiving mapping information including data defining mappings between a first framework defining input animations of an AR media communication session and corresponding output animations of a second framework to be used to animate a base avatar model of a user participating in the AR media communication session; receiving an animation stream for the user, the animation stream including data for one or more of the input animations; determining a subset of the output animations to be used to animate the base avatar model of the user using the mapping information and the one or more of the input animations from the animation stream; and animating the base avatar model using the subset of the output animations.

Various examples of the techniques of this disclosure are summarized in the following clauses:

Clause 1: A method of communicating extended reality (XR) media data, the method comprising: receiving an identifier for a tracking framework used to track movements of a user engaged in an XR communication session; determining whether the identifier for the tracking framework matches a framework for a base avatar corresponding to the user; when the identifier for the tracking framework does not match the framework for the base avatar: retrieving mapping information for converting movement data expressed in the tracking framework to the framework for the base avatar; receiving an animation stream representing at least one movement of the user; converting the animation stream using the mapping information to form a converted animation stream; and using the converted animation stream to animate the base avatar.

Clause 2: The method of clause 1, further comprising displaying the animated base avatar.

Clause 3: The method of any of clauses 1 and 2, wherein receiving the identifier for the tracking framework comprises retrieving the identifier from a registry of tracking framework identifiers.

Clause 4: The method of any of clauses 1-3, wherein the identifier for the tracking framework comprises a globally unique and self-assigned identifier.

Clause 5: The method of clause 4, wherein the identifier comprises a uniform resource name (URN).

Clause 6: The method of any of clauses 1-5, wherein the identifier uniquely identifies facial blendshapes and corresponding facial expressions as an ordered list.

Clause 7: The method of any of clauses 1-6, wherein the identifier uniquely identifies body joints and a hierarchy of the body joints.

Clause 8: The method of any of clauses 1-7, wherein the identifier corresponds to an OpenXR extension name.

Clause 9: The method of any of clauses 1-8, wherein the mapping information comprises a matrix associating animation stream parameters for the tracking framework with parameters used by the base avatar.

Clause 10: The method of clause 9, wherein the matrix includes coefficients at intersections between the animation stream parameters and the parameters used by the base avatar.

Clause 11: The method of any of clauses 1-10, wherein the mapping information includes an information section, a facial section, a body section, and a hand section.

Clause 12: A device for communicating extended reality (XR) media data, the device comprising one or more means for performing the method of any of clauses 1-11.

Clause 13: The device of clause 12, wherein the one or more means comprise a processing system implemented in circuitry, and a memory configured to store XR media data.

Clause 14: A device for communicating media data, the device comprising: means for receiving an identifier for a tracking framework used to track movements of a user engaged in an XR communication session; means for determining whether the identifier for the tracking framework matches a framework for a base avatar corresponding to the user; means for retrieving mapping information for converting movement data expressed in the tracking framework to the framework for the base avatar when the identifier for the tracking framework does not match the framework for the base avatar; means for receiving an animation stream representing at least one movement of the user; means for converting the animation stream using the mapping information to form a converted animation stream when the identifier for the tracking framework does not match the framework for the base avatar; and means for using the converted animation stream to animate the base avatar when the identifier for the tracking framework does not match the framework for the base avatar.

Clause 15: A method of communicating extended reality (XR) media data, the method comprising: receiving mapping information including data defining mappings between a first framework defining input animations of an AR media communication session and corresponding output animations of a second framework to be used to animate a base avatar model of a user participating in the AR media communication session; receiving an animation stream for the user, the animation stream including data for one or more of the input animations; determining a subset of the output animations to be used to animate the base avatar model of the user using the mapping information and the one or more of the input animations from the animation stream; and animating the base avatar model using the subset of the output animations.

Clause 16: The method of clause 15, wherein receiving the mapping information further comprises receiving weight values to be applied to the input animations to form a corresponding output animation of the output animations.

Clause 17: The method of clause 15, wherein receiving the mapping information further comprises receiving a transform matrix to be used when determining the subset of the output animations.

Clause 18: The method of clause 15, wherein animating the base avatar model comprises generating an animated avatar, the method further comprising displaying the animated avatar.

Clause 19: The method of clause 15, wherein the input animations include one or more input blendshapes and one or more input joint animations, and wherein the output animations include one or more output blendshapes and one or more output joint animations.

Clause 20: The method of clause 15, further comprising: receiving an identifier for the first framework; and determining whether the identifier for the first framework matches an identifier for the second framework for a base avatar corresponding to the user, wherein receiving the mapping information comprises retrieving the mapping information when the identifier for the first framework does not match the identifier for the second framework.

Clause 21: The method of clause 20, wherein receiving the identifier for the first framework comprises retrieving the identifier from a registry of framework identifiers.

Clause 22: The method of clause 20, wherein the identifier for the first framework comprises a globally unique and self-assigned identifier.

Clause 23: The method of clause 22, wherein the identifier comprises a uniform resource name (URN).

Clause 24: The method of clause 20, wherein the identifier uniquely identifies facial blendshapes and corresponding facial expressions as an ordered list.

Clause 25: The method of clause 20, wherein the identifier uniquely identifies body joints and a hierarchy of the body joints.

Clause 26: The method of clause 20, wherein the identifier corresponds to an OpenXR extension name.

Clause 27: The method of clause 15, wherein the mapping information comprises a matrix associating animation stream parameters for a tracking framework with parameters used by the base avatar model.

Clause 28: The method of clause 27, wherein the matrix includes coefficients at intersections between the animation stream parameters and the parameters used by the base avatar model.

Clause 29: The method of clause 15, wherein the mapping information includes an information section, a facial section, a body section, and a hand section.

Clause 30: A device for communicating augmented reality (AR) media data, the device comprising: a memory configured to store AR media data; and a processing system implemented in circuitry and configured to: receive mapping information including data defining mappings between a first framework defining input animations of an AR media communication session and corresponding output animations of a second framework to be used to animate a base avatar model of a user participating in the AR media communication session; receive an animation stream for the user, the animation stream including data for one or more of the input animations; determine a subset of the output animations to be used to animate the base avatar model of the user using the mapping information and the one or more of the input animations from the animation stream; and animate the base avatar model using the subset of the output animations.

Clause 31: The device of clause 30, wherein the mapping information includes weight values to be applied to the input animations to form a corresponding output animation of the output animations, and wherein to determine the subset of the output animations, the processing system is configured to apply the weight values to the one or more of the input animations to form the subset of the output animations.

Clause 32: The device of clause 30, wherein the mapping information includes a transform matrix to be used when determining the subset of the output animations, and wherein the processing system is configured to use the transform matrix to determine the subset of the output animations.

Clause 33: The device of clause 30, wherein the processing system is configured to generate an animated avatar from animating the base avatar model, and wherein the processing system is further configured to display the animated avatar.

Clause 34: The device of clause 30, wherein the input animations include one or more input blendshapes and one or more input joint animations, and wherein the output animations include one or more output blendshapes and one or more output joint animations.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of communicating augmented reality (AR) media data, the method comprising:
receiving mapping information including data defining mappings between a first framework defining input animations of an AR media communication session and corresponding output animations of a second framework to be used to animate a base avatar model of a user participating in the AR media communication session;
receiving an animation stream for the user, the animation stream including data for one or more of the input animations;
determining a subset of the output animations to be used to animate the base avatar model of the user using the mapping information and the one or more of the input animations from the animation stream; and
animating the base avatar model using the subset of the output animations.

2. The method of claim 1, wherein receiving the mapping information further comprises receiving weight values to be applied to the input animations to form a corresponding output animation of the output animations.

3. The method of claim 1, wherein receiving the mapping information further comprises receiving a transform matrix to be used when determining the subset of the output animations.

4. The method of claim 1, wherein animating the base avatar model comprises generating an animated avatar, the method further comprising displaying the animated avatar.

5. The method of claim 1, wherein the input animations include one or more input blendshapes and one or more input joint animations, and wherein the output animations include one or more output blendshapes and one or more output joint animations.

6. The method of claim 1, further comprising:
receiving an identifier for the first framework; and
determining whether the identifier for the first framework matches an identifier for the second framework for a base avatar corresponding to the user,
wherein receiving the mapping information comprises retrieving the mapping information when the identifier for the first framework does not match the identifier for the second framework.

7. The method of claim 6, wherein receiving the identifier for the first framework comprises retrieving the identifier from a registry of framework identifiers.

8. The method of claim 6, wherein the identifier for the first framework comprises a globally unique and self-assigned identifier.

9. The method of claim 8, wherein the identifier comprises a uniform resource name (URN).

10. The method of claim 6, wherein the identifier uniquely identifies facial blendshapes and corresponding facial expressions as an ordered list.

11. The method of claim 6, wherein the identifier uniquely identifies body joints and a hierarchy of the body joints.

12. The method of claim 6, wherein the identifier corresponds to an OpenXR extension name.

13. The method of claim 1, wherein the mapping information comprises a matrix associating animation stream parameters for a tracking framework with parameters used by the base avatar model.

14. The method of claim 13, wherein the matrix includes coefficients at intersections between the animation stream parameters and the parameters used by the base avatar model.

15. The method of claim 1, wherein the mapping information includes an information section, a facial section, a body section, and a hand section.

16. A device for communicating augmented reality (AR) media data, the device comprising:
a memory configured to store AR media data; and
a processing system implemented in circuitry and configured to:
receive mapping information including data defining mappings between a first framework defining input animations of an AR media communication session and corresponding output animations of a second framework to be used to animate a base avatar model of a user participating in the AR media communication session;
receive an animation stream for the user, the animation stream including data for one or more of the input animations;
determine a subset of the output animations to be used to animate the base avatar model of the user using the mapping information and the one or more of the input animations from the animation stream; and
animate the base avatar model using the subset of the output animations.

17. The device of claim 16, wherein the mapping information includes weight values to be applied to the input animations to form a corresponding output animation of the output animations, and wherein to determine the subset of the output animations, the processing system is configured to apply the weight values to the one or more of the input animations to form the subset of the output animations.

18. The device of claim 16, wherein the mapping information includes a transform matrix to be used when determining the subset of the output animations, and wherein the processing system is configured to use the transform matrix to determine the subset of the output animations.

19. The device of claim 16, wherein the processing system is configured to generate an animated avatar from animating the base avatar model, and wherein the processing system is further configured to display the animated avatar.

20. The device of claim 16, wherein the input animations include one or more input blendshapes and one or more input joint animations, and wherein the output animations include one or more output blendshapes and one or more output joint animations.
